(19) United States
(12) Patent Application Publication
(10) Pub. No.: US 2024/0057100 A1
(43) Pub. Date: Feb. 15, 2024

(54) METHOD AND APPARATUS FOR MBS RECEPTION IN RRC IDLE AND RRC INACTIVE STATE IN WIRELESS COMMUNICATION SYSTEM

(71) Applicant: SAMSUNG ELECTRONICS CO., LTD., Suwon-si, Gyeonggi-do (KR)

(72) Inventor: Anil AGIWAL, Suwon-si (KR)

(21) Appl. No.: 18/258,155

(22) PCT Filed: Dec. 1, 2021
(86) PCT No.: PCT/KR2021/017962

§ 371 Date: Jun. 16, 2023

(30) Foreign Application Priority Data
Dec. 17, 2020 (KR) 10-2020-0177524

(51) Int. Cl. H04W 72/23; H04W 4/06

(52) U.S. Cl. CPC H04W 72/23; H04W 4/06

(57) ABSTRACT

The present disclosure relates to a communication method and system for converging a 5th-Generation (5G) communication system for supporting higher data rates beyond a 4th-Generation (4G) system with a technology for Internet of Things (IoT). The present disclosure may be applied to intelligent services based on the 5G communication technology and the IoT-related technology, such as smart home, smart building, smart city, smart car, connected car, health care, digital education, smart retail, security and safety services. The present disclosure provides method and apparatus for MBS reception or MBMS reception in RRC idle/inactive state.

### CROSS-REFERENCE TO RELATED APPLICATIONS

This application is a 371 of International Application No. PCT/KR2021/017962 filed on Dec. 1, 2021, which claims priority to Korean Patent Application No. 10-2020-0177524 filed on Dec. 17, 2020, the disclosures of which are herein incorporated by reference in their entirety.

### BACKGROUND

### 1. Field

The disclosure relates to a wireless communication system. Specifically, the disclosure relates to an apparatus, a method and a system for multimedia broadcast service (MBS) reception or multimedia broadcast multicast service (MBMS) reception in radio resource control (RRC) idle state and RRC inactive state in wireless communication system.

### 2. Description of Related Art

To meet the demand for wireless data traffic having increased since deployment of 4G communication systems, efforts have been made to develop an improved 5G or pre-5G communication system. Therefore, the 5G or pre-5G communication system is also called a ‘Beyond 4G Network’ or a ‘Post LTE System’. The 5G communication system is considered to be implemented in higher frequency (mmWave) bands, e.g., 60 GHz bands, so as to accomplish higher data rates. To decrease propagation loss of the radio waves and increase the transmission distance, the beamforming, massive multiple-input multiple-output (MIMO), Full Dimensional MIMO (FD-MIMO), array antenna, an analog beam forming, large scale antenna techniques are discussed in 5G communication systems. In addition, in 5G communication systems, development for system network improvement is under way based on advanced small cells, cloud Radio Access Networks (RANs), ultra-dense networks, device-to-device (D2D) communication, wireless backhaul, moving network, cooperative communication, Coordinated Multi-Points (CoMP), reception-end interference cancellation and the like. In the 5G system, Hybrid FSK and QAM Modulation (FQAM) and sliding window superposition coding (SWSC) as an advanced coding modulation (ACM), and filter bank multi carrier (FBMC), non-orthogonal multiple access (NOMA), and sparse code multiple access (SCMA) as an advanced access technology have been developed.

The Internet, which is a human centered connectivity network where humans generate and consume information, is now evolving to the Internet of Things (IoT) where distributed entities, such as things, exchange and process information without human intervention. The Internet of Everything (IoE), which is a combination of the IoT technology and the Big Data processing technology through connection with a cloud server, has emerged. As technology elements, such as “sensing technology”, “wired/wireless communication and network infrastructure”, “service interface technology”, and “Security technology” have been demanded for IoT implementation, a sensor network, a Machine-to-Machine (M2M) communication, Machine Type Communication (MTC), and so forth have been recently researched. Such an IoT environment may provide intelligent Internet technology services that create a new value to human life by collecting and analyzing data generated among connected things. IoT may be applied to a variety of fields including smart home, smart building, smart city, smart car or connected cars, smart grid, health care, smart appliances and advanced medical services through convergence and combination between existing Information Technology (IT) and various industrial applications.

In line with this, various attempts have been made to apply 5G communication systems to IoT networks. For example, technologies such as a sensor network, Machine Type Communication (MTC), and Machine-to-Machine (M2M) communication may be implemented by beamforming, MIMO, and array antennas. Application of a cloud Radio Access Network (RAN) as the above-described Big Data processing technology may also be considered to be as an example of convergence between the 5G technology and the IoT technology.

Recently, there are needs to enhance multimedia broadcast service (MBS) or multimedia broadcast multicast service (MBMS) reception for next generation wireless communication system.

### SUMMARY

There are needs to enhance MBS or MBMS reception for next generation wireless communication system.

Aspects of the disclosure are to address at least the above-mentioned problems and/or disadvantages and to provide at least the advantages described below. Accordingly, an aspect of the disclosure is to provide a communication method and system for converging a fifth generation (5G) communication system for supporting higher data rates beyond a fourth generation (4G).

In accordance with an aspect of the disclosure, a method performed by a terminal is provided. The method comprises: receiving, from a base station, search space configuration information associated with physical downlink control channel (PDCCH) monitoring occasion for a multimedia broadcast service (MBS) and monitoring window configuration information for the MBS; identifying at least one PDCCH monitoring occasion within a MBS window based on the search space configuration information and the monitoring window configuration information, wherein each of the at least one PDCCH monitoring occasion within the MBS window corresponds to one synchronization signal block (SSB); and receiving, from the base station while the terminal is in a radio resource control (RRC) idle state or an RRC inactive state, an MBS data by monitoring a PDCCH monitoring occasion among the at least one PDCCH monitoring occasion within the MBS window.

In accordance with another aspect of the disclosure, a method performed by a base station is provided. The method comprises: transmitting, to a terminal, search space configuration information associated with physical downlink control channel (PDCCH) monitoring occasion for a multimedia broadcast service (MBS) and monitoring window configuration information for the MBS; identifying at least one PDCCH monitoring occasion within a MBS window based on the search space configuration information and the monitoring window configuration information, wherein each of the at least one PDCCH monitoring occasion within the MBS window corresponds to one synchronization signal block (SSB); and transmitting, to the terminal in a radio resource control (RRC) idle state or an RRC inactive state, an MBS data based on a PDCCH monitoring occasion among the at least one PDCCH monitoring occasion within the MBS window.

In accordance with another aspect of the disclosure, a terminal is provided. The terminal comprises a transceiver configured to transmit or receive a signal; and a controller configured to: receive, from a base station, search space configuration information associated with physical downlink control channel (PDCCH) monitoring occasion for a multimedia broadcast service (MBS) and monitoring window configuration information for the MBS, identify at least one PDCCH monitoring occasion within a MBS window based on the search space configuration information and the monitoring window configuration information, wherein each of the at least one PDCCH monitoring occasion within the MBS window corresponds to one synchronization signal block (SSB), and receive, from the base station while the terminal is in a radio resource control (RRC) idle state or an RRC inactive state, an MBS data by monitoring a PDCCH monitoring occasion among the at least one PDCCH monitoring occasion within the MBS window.

In accordance with another aspect of the disclosure, a base station is provided. The base station comprises a transceiver configured to transmit or receive a signal; and a controller configured to: transmit, to a terminal, search space configuration information associated with physical downlink control channel (PDCCH) monitoring occasion for a multimedia broadcast service (MBS) and monitoring window configuration information for the MBS, identify at least one PDCCH monitoring occasion within a MBS window based on the search space configuration information and the monitoring window configuration information, wherein each of the at least one PDCCH monitoring occasion within the MBS window corresponds to one synchronization signal block (SSB), and transmit, to the terminal in a radio resource control (RRC) idle state or an RRC inactive state, an MBS data based on a PDCCH monitoring occasion among the at least one PDCCH monitoring occasion within the MBS window.

### BRIEF DESCRIPTION OF THE DRAWINGS

According to various embodiments of the disclosure, MBS or MBMS reception procedure can be efficiently enhanced.

The above and other aspects, features, and advantages of certain embodiments of the disclosure will be more apparent from the following description taken in conjunction with the accompanying drawings, in which.

FIG. 1 illustrates an example of MBMS reception in accordance with an embodiment of the disclosure.

FIG. 2 illustrates another example of MBMS reception in accordance with another embodiment of the disclosure.

FIG. 3 illustrates another example of MBMS reception in accordance with another embodiment of the disclosure.

FIG. 4 illustrates another example of MBMS reception in accordance with another embodiment of the disclosure.

FIG. 5 illustrates another example of MBMS reception in accordance with another embodiment of the disclosure.

FIG. 6 is a block diagram of a terminal according to an embodiment of the disclosure; and

FIG. 7 is a block diagram of a base station according to an embodiment of the disclosure.

Throughout the drawings, like reference numerals will be understood to refer to like parts, components, and structures.

### DETAILED DESCRIPTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

By the term “substantially” it is meant that the recited characteristic, parameter, or value need not be achieved exactly, but that deviations or variations, including for example, tolerances, measurement error, measurement accuracy limitations and other factors known to those of skill in the art, may occur in amounts that do not preclude the effect the characteristic was intended to provide.

It is known to those skilled in the art that blocks of a flowchart (or sequence diagram) and a combination of flowcharts may be represented and executed by computer program instructions. These computer program instructions may be loaded on a processor of a general purpose computer, special purpose computer, or programmable data processing equipment. When the loaded program instructions are executed by the processor, they create a means for carrying out functions described in the flowchart. Because the computer program instructions may be stored in a computer readable memory that is usable in a specialized computer or a programmable data processing equipment, it is also possible to create articles of manufacture that carry out functions described in the flowchart. Because the computer program instructions may be loaded on a computer or a programmable data processing equipment, when executed as processes, they may carry out operations of functions described in the flowchart.

A block of a flowchart may correspond to a module, a segment, or a code containing one or more executable instructions implementing one or more logical functions, or may correspond to a part thereof. In some cases, functions described by blocks may be executed in an order different from the listed order. For example, two blocks listed in sequence may be executed at the same time or executed in reverse order.

In this description, the words “unit”, “module” or the like may refer to a software component or hardware component, such as, for example, a field-programmable gate array (FPGA) or an application-specific integrated circuit (ASIC) capable of carrying out a function or an operation. However, a “unit”, or the like, is not limited to hardware or software. A unit, or the like, may be configured so as to reside in an addressable storage medium or to drive one or more processors. Units, or the like, may refer to software components, object-oriented software components, class components, task components, processes, functions, attributes, procedures, subroutines, program code segments, drivers, firmware, microcode, circuits, data, databases, data structures, tables, arrays or variables. A function provided by a component and unit may be a combination of smaller components and units, and may be combined with others to compose larger components and units. Components and units may be configured to drive a device or one or more processors in a secure multimedia card.

Prior to the detailed description, terms or definitions necessary to understand the disclosure are described. However, these terms should be construed in a non-limiting way.

The “base station (BS)” is an entity communicating with a user equipment (UE) and may be referred to as BS, base transceiver station (BTS), node B (NB), evolved NB (eNB), access point (AP), 5G NB (5GNB), or gNB.

The “UE” is an entity communicating with a BS and may be referred to as UE, device, mobile station (MS), mobile equipment (ME), or terminal.

In the recent years several broadband wireless technologies have been developed to meet the growing number of broadband subscribers and to provide more and better applications and services. The second generation wireless communication system has been developed to provide voice services while ensuring the mobility of users. Third generation wireless communication system supports not only the voice service but also data service. In recent years, the fourth wireless communication system has been developed to provide high-speed data service. However, currently, the fourth generation wireless communication system suffers from lack of resources to meet the growing demand for high speed data services. So fifth generation wireless communication system is being developed to meet the growing demand for high speed data services, support ultra-reliability and low latency applications.

The fifth generation wireless communication system will be implemented not only in lower frequency bands but also in higher frequency (mmWave) bands, e.g., 10 GHz to 100 GHz bands, so as to accomplish higher data rates. To mitigate propagation loss of the radio waves and increase the transmission distance, the beamforming, massive Multiple-Input Multiple-Output (MIMO), Full Dimensional MIMO (FD-MIMO), array antenna, an analog beam forming, large scale antenna techniques are being considered in the design of fifth generation wireless communication system. In addition, the fifth generation wireless communication system is expected to address different use cases having quite different requirements in terms of data rate, latency, reliability, mobility etc. However, it is expected that the design of the air-interface of the fifth generation wireless communication system would be flexible enough to serve the UEs having quite different capabilities depending on the use case and market segment the UE cater service to the end customer. Few example use cases the fifth generation wireless communication system wireless system is expected to address is enhanced Mobile Broadband (eMBB), massive Machine Type Communication (m-MTC), ultra-reliable low latency communication (URLL) etc. The eMBB requirements like tens of Gbps data rate, low latency, high mobility so on and so forth address the market segment representing the conventional wireless broadband subscribers needing internet connectivity everywhere, all the time and on the go. The m-MTC requirements like very high connection density, infrequent data transmission, very long battery life, low mobility address so on and so forth address the market segment representing the Internet of Things (IoT)/Internet of Everything (IoE) envisioning connectivity of billions of devices. The URLL requirements like very low latency, very high reliability and variable mobility so on and so forth address the market segment representing the Industrial automation application, vehicle-to-vehicle/vehicle-to-infrastructure communication foreseen as one of the enabler for autonomous cars.

In the fifth generation wireless communication system operating in higher frequency (mmWave) bands, UE and gNB communicates with each other using Beamforming. Beamforming techniques are used to mitigate the propagation path losses and to increase the propagation distance for communication at higher frequency band. Beamforming enhances the transmission and reception performance using a high-gain antenna. Beamforming can be classified into Transmission (TX) beamforming performed in a transmitting end and reception (RX) beamforming performed in a receiving end. In general, the TX beamforming increases directivity by allowing an area in which propagation reaches to be densely located in a specific direction by using a plurality of antennas.

In this situation, aggregation of the plurality of antennas can be referred to as an antenna array, and each antenna included in the array can be referred to as an array element. The antenna array can be configured in various forms such as a linear array, a planar array, etc. The use of the TX beamforming results in the increase in the directivity of a signal, thereby increasing a propagation distance. Further, since the signal is almost not transmitted in a direction other than a directivity direction, a signal interference acting on another receiving end is significantly decreased. The receiving end can perform beamforming on a RX signal by using a RX antenna array. The RX beamforming increases the RX signal strength transmitted in a specific direction by allowing propagation to be concentrated in a specific direction, and excludes a signal transmitted in a direction other than the specific direction from the RX signal, thereby providing an effect of blocking an interference signal.

By using beamforming technique, a transmitter can make plurality of transmit beam patterns of different directions. Each of these transmit beam patterns can be also referred as TX beam. Wireless communication system operating at high frequency uses plurality of narrow TX beams to transmit signals in the cell as each narrow TX beam provides coverage to a part of cell. The narrower the TX beam, higher is the antenna gain and hence the larger the propagation distance of signal transmitted using beamforming. A receiver can also make plurality of RX beam patterns of different directions. Each of these receive patterns can be also referred as RX beam.

The fifth generation wireless communication system (also referred as next generation radio or NR), supports standalone mode of operation as well dual connectivity (DC). In DC a multiple Rx/Tx UE may be configured to utilize resources provided by two different nodes (or NBs) connected via non-ideal backhaul. One node acts as the Master Node (MN) and the other as the Secondary Node (SN). The MN and SN are connected via a network interface and at least the MN is connected to the core network. NR also supports Multi-RAT Dual Connectivity (MR-DC) operation whereby a UE in radio resource control connected (RRC_CONNECTED) is configured to utilize radio resources provided by two distinct schedulers, located in two different nodes connected via a non-ideal backhaul and providing either E-UTRA (Evolved Universal Mobile Telecommunications System (UMTS) Terrestrial Radio Access) (i.e. if the node is an ng-eNB) or NR access (i.e. if the node is a gNB). In NR for a UE in RRC_CONNECTED not configured with carrier aggregation (CA)/DC there is only one serving cell comprising of the primary cell. For a UE in RRC_CONNECTED configured with CA/DC the term ‘serving cells’ is used to denote the set of cells comprising of the Special Cell(s) and all secondary cells. In NR the term Master Cell Group (MCG) refers to a group of serving cells associated with the Master Node, comprising of the Primary Cell (PCell) and optionally one or more Secondary Cells (SCells). In NR the term Secondary Cell Group (SCG) refers to a group of serving cells associated with the Secondary Node, comprising of the Primary SCG Cell (PSCell) and optionally one or more SCells. In NR PCell refers to a serving cell in MCG, operating on the primary frequency, in which the UE either performs the initial connection establishment procedure or initiates the connection re-establishment procedure. In NR for a UE configured with CA, Scell is a cell providing additional radio resources on top of Special Cell. PSCell refers to a serving cell in SCG in which the UE performs random access when performing the Reconfiguration with Sync procedure. For Dual Connectivity operation the term SpCell (i.e. Special Cell) refers to the PCell of the MCG or the PSCell of the SCG, otherwise the term Special Cell refers to the PCell.

In the fifth generation wireless communication system (or NR), Physical Downlink Control Channel (PDCCH) is used to schedule downlink (DL) transmissions on Physical Downlink Shared Channel (PDSCH) and uplink (UL) transmissions on Physical Uplink Shared Channel (PUSCH), where the Downlink Control Information (DCI) on PDCCH includes: Downlink assignments containing at least modulation and coding format, resource allocation, and hybrid automatic repeat request (HARQ) information related to downlink shared channel (DL-SCH); Uplink scheduling grants containing at least modulation and coding format, resource allocation, and hybrid-ARQ information related to uplink shared channel (UL-SCH). In addition to scheduling, PDCCH can be used to for: Activation and deactivation of configured PUSCH transmission with configured grant; Activation and deactivation of PDSCH semi-persistent transmission; Notifying one or more UEs of the slot format; Notifying one or more UEs of the physical resource block(s) (PRB(s)) and orthogonal frequency division multiplexing (OFDM) symbol(s) where the UE may assume no transmission is intended for the UE; Transmission of transmission power control (TPC) commands for Physical Uplink Control Channel (PUCCH) and PUSCH; Transmission of one or more TPC commands for sounding reference signal (SRS) transmissions by one or more UEs; Switching a UE's active bandwidth part; Initiating a random access procedure.

A UE monitors a set of PDCCH candidates in the configured monitoring occasions in one or more configured COntrol REsource SETs (CORESETs) according to the corresponding search space configurations. A CORESET consists of a set of PRBs with a time duration of 1 to 3 OFDM symbols. The resource units Resource Element Groups (REGs) and Control Channel Elements (CCEs) are defined within a CORESET with each CCE consisting a set of REGs. Control channels are formed by aggregation of CCE. Different code rates for the control channels are realized by aggregating different number of CCE. Interleaved and non-interleaved CCE-to-REG mapping are supported in a CORESET. Polar coding is used for PDCCH. Each resource element group carrying PDCCH carries its own demodulation reference signal (DMRS). Quadrature phase shift keying (QPSK) modulation is used for PDCCH.

In NR, a list of search space configurations are signaled by gNB for each configured bandwidth part (BWP) wherein each search configuration is uniquely identified by an identifier. Identifier of search space configuration to be used for specific purpose such as paging reception, system information (SI) reception, random access response (RAR) reception is explicitly signaled by gNB. In NR search space configuration comprises of parameters Monitoring-periodicity-PDCCH-slot, Monitoring-offset-PDCCH-slot, Monitoring-symbols-PDCCH-within-slot and duration. A UE determines PDCCH monitoring occasion (s) within a slot using the parameters PDCCH monitoring periodicity (Monitoring-periodicity-PDCCH-slot), the PDCCH monitoring offset (Monitoring-offset-PDCCH-slot), and the PDCCH monitoring pattern (Monitoring-symbols-PDCCH-within-slot). PDCCH monitoring occasions are there in slots ‘x’ to x+duration where the slot with number ‘x’ in a radio frame with number ‘y’ satisfies the equation 1 below.

(y*(number of slots in a radio frame)+x−Monitoring-offset-PDCCH-slot)mod (Monitoring-periodicity-PDCCH-slot)=0; [equation 1]

The starting symbol of a PDCCH monitoring occasion in each slot having PDCCH monitoring occasion is given by Monitoring-symbols-PDCCH-within-slot. The length (in symbols) of a PDCCH monitoring occasion is given in the corset associated with the search space. search space configuration includes the identifier of CORESET configuration associated with it. A list of CORESET configurations are signaled by gNB for each configured BWP wherein each CORESET configuration is uniquely identified by an identifier. Note that each radio frame is of 10 ms duration. Radio frame is identified by a radio frame number or system frame number. Each radio frame comprises of several slots wherein the number of slots in a radio frame and duration of slots depends on sub carrier spacing. The number of slots in a radio frame and duration of slots depends radio frame for each supported subcarrier spacing (SCS) is pre-defined in NR. Each CORESET configuration is associated with a list of TCI (Transmission configuration indicator) states. One DL reference signal (RS) identifier (ID) (SSB or channel state information reference signal (CSI-RS)) is configured per TCI state. The list of TCI states corresponding to a CORESET configuration is signaled by gNB via RRC signaling. One of the TCI state in TCI state list is activated and indicated to UE by gNB. TCI state indicates the DL TX beam (DL TX beam is quasi-collocated (QCLed) with SSB/CSI RS of TCI state) used by GNB for transmission of PDCCH in the PDCCH monitoring occasions of a search space.

In NR bandwidth adaptation (BA) is supported. With BA, the receive and transmit bandwidth of a UE need not be as large as the bandwidth of the cell and can be adjusted: the width can be ordered to change (e.g. to shrink during period of low activity to save power); the location can move in the frequency domain (e.g. to increase scheduling flexibility), and the subcarrier spacing can be ordered to change (e.g. to allow different services). A subset of the total cell bandwidth of a cell is referred to as a Bandwidth Part (BWP).

BA is achieved by configuring RRC connected UE with BWP(s) and telling the UE which of the configured BWPs is currently the active one. When BA is configured, the UE only has to monitor PDCCH on the one active BWP i.e. it does not have to monitor PDCCH on the entire DL frequency of the serving cell. In RRC connected state, UE is configured with one or more DL and UL BWPs, for each configured Serving Cell (i.e. PCell or SCell). For an activated Serving Cell, there is always one active UL and DL BWP at any point in time. The BWP switching for a Serving Cell is used to activate an inactive BWP and deactivate an active BWP at a time. The BWP switching is controlled by the PDCCH indicating a downlink assignment or an uplink grant, by the bwp-InactivityTimer, by RRC signaling, or by the medium access control (MAC) entity itself upon initiation of Random Access procedure. Upon addition of SpCell or activation of an SCell, the DL BWP and UL BWP indicated by firstActiveDownlinkBWP-Id and firstActiveUplinkBWP-Id respectively is active without receiving PDCCH indicating a downlink assignment or an uplink grant. The active BWP for a Serving Cell is indicated by either RRC or PDCCH. For unpaired spectrum, a DL BWP is paired with a UL BWP, and BWP switching is common for both UL and DL. Upon expiry of BWP inactivity timer UE switch to the active DL BWP to the default DL BWP or initial DL BWP (if default DL BWP is not configured).

In the fifth generation wireless communication system, RRC can be in one of the following states: RRC_IDLE, RRC_INACTIVE, and RRC_CONNECTED. A UE is either in RRC_CONNECTED state or in RRC_INACTIVE state when an RRC connection has been established. If this is not the case, i.e. no RRC connection is established, the UE is in RRC_IDLE state. The RRC states can further be characterized as follows:

In the RRC_IDLE, a UE specific discontinuous (DRX) may be configured by upper layers. The UE monitors Short Messages transmitted with paging RNTI (P-RNTI) over DCI; monitors a Paging channel for CN paging using 5G-S-temporary mobile subscriber identity (5G-S-TMSI); performs neighboring cell measurements and cell (re-)selection; acquires system information and can send SI request (if configured); performs logging of available measurements together with location and time for logged measurement configured UEs.

In RRC_INACTIVE, a UE specific DRX may be configured by upper layers or by RRC layer; UE stores the UE Inactive AS context; a RAN-based notification area is configured by RRC layer. The UE monitors Short Messages transmitted with P-RNTI over DCI; monitors a Paging channel for CN paging using 5G-S-TMSI and RAN paging using fullI-RNTI; performs neighboring cell measurements and cell (re-)selection; performs RAN-based notification area updates periodically and when moving outside the configured RAN-based notification area; acquires system information and can send SI request (if configured); performs logging of available measurements together with location and time for logged measurement configured UEs.

In the RRC_CONNECTED, the UE stores the AS context and transfer of unicast data to/from UE takes place. The UE monitors Short Messages transmitted with P-RNTI over DCI, if configured; monitors control channels associated with the shared data channel to determine if data is scheduled for it; provides channel quality and feedback information; performs neighboring cell measurements and measurement reporting; acquires system information.

In the RRC_CONNECTED, network may initiate suspension of the RRC connection by sending RRCRelease with suspend configuration. When the RRC connection is suspended, the UE stores the UE Inactive AS context and any configuration received from the network, and transits to RRC_INACTIVE state. If the UE is configured with SCG, the UE releases the SCG configuration upon initiating a RRC Connection Resume procedure. The RRC message to suspend the RRC connection is integrity protected and ciphered.

The resumption of a suspended RRC connection is initiated by upper layers when the UE needs to transit from RRC_INACTIVE state to RRC_CONNECTED state or by RRC layer to perform a RAN based notification area (RNA) update or by RAN paging from NG-RAN. When the RRC connection is resumed, network configures the UE according to the RRC connection resume procedure based on the stored UE Inactive AS context and any RRC configuration received from the network. The RRC connection resume procedure re-activates AS security and re-establishes signaling radio bearer(s) (SRB(s)) and data radio bearer(s) (DRB(s)). In response to a request to resume the RRC connection, the network may resume the suspended RRC connection and send UE to RRC_CONNECTED, or reject the request to resume and send UE to RRC_INACTIVE (with a wait timer), or directly re-suspend the RRC connection and send UE to RRC_INACTIVE, or directly release the RRC connection and send UE to RRC_IDLE, or instruct the UE to initiate NAS level recovery (in this case the network sends an RRC setup message).

Upon initiating the resume procedure, UE:
apply the default L1 parameter values as specified in corresponding physical layer specifications, except for the parameters for which values are provided in SIB1;
apply the default medium access control (MAC) Cell Group configuration
apply the common control channel (CCCH) configuration
start timer T319;
apply the timeAlignmentTimerCommon included in SIB1
apply the default SRB1 configuration
set the variable pendingRNA-Update to false;
   initiate transmission of the RRCResumeRequest message or RRCResumeRequest1
   restore the RRC configuration, RoHC state, the stored QoS flow to DRB mapping rules and the KgNB and KRRCint keys from the stored UE Inactive AS context except for the following:
      masterCellGroup;
      mrdc-SecondaryCellGroup, if stored; and
      pdcp-Config;
   set the resumeMAC-I to the 16 least significant bits of the MAC-I calculated:
      over the ASN.1 encoded as per clause 8 (i.e., a multiple of 8 bits) VarResumeMAC-Input;
      with the KRRCint key in the UE Inactive AS Context and the previously configured integrity protection algorithm; and
      with all input bits for COUNT, BEARER and DIRECTION set to binary ones;
   derive the KgNB key based on the current KgNB key or the NH, using the stored nextHopChainingCount value;
   derive the KRRCenc key, the KRRCint key, the KUPint key and the KUPenc key;
   configure lower layers to apply integrity protection for all signaling radio bearers except SRB0 using the configured algorithm and the KRRCint key and KUPint key, i.e., integrity protection shall be applied to all subsequent messages received and sent by the UE;
   configure lower layers to apply ciphering for all signaling radio bearers except SRB0 and to apply the configured ciphering algorithm, the KRRCenc key and the KUPenc key derived, i.e. the ciphering configuration shall be applied to all subsequent messages received and sent by the UE;
   re-establish packet data convergence protocol (PDCP) entities for SRB1;
   resume SRB1;
   transmit RRCResumeRequest or RRCResumeRequest1.

The 5G or Next Generation Radio Access Network (NG-RAN) based on NR consists of NG-RAN nodes where NG-RAN node is a gNB, providing NR user plane and control plane protocol terminations towards the UE. The gNBs are also connected by means of the NG interfaces to the 5G core (5GC), more specifically to the AMF (Access and Mobility Management Function) by means of the NG-C interface and to the UPF (User Plane Function) by means of the NG-U interface. In the 5th generation (also referred as NR) wireless communication system, the UE may use DRX in RRC_IDLE and RRC_INACTIVE state in order to reduce power consumption. In the RRC_IDLE/RRC_INACTIVE state UE wakes up at regular intervals (i.e. every DRX cycle) for short periods to receive paging, to receive system information (SI) update notification and to receive emergency notifications. Paging message is transmitted using PDSCH. PDCCH is addressed to P-RNTI if there is a paging message in PDSCH. P-RNTI is common for all UEs. UE identity (i.e. S-TMSI for RRC_IDLE UE or I-RNTI for RRC_INACTIVE UE) is included in paging message to indicate paging for a specific UE. Paging message may include multiple UE identities to page multiple UEs. Paging message is broadcasted (i.e. PDCCH is masked with P-RNTI) over data channel (i.e. PDSCH). SI update and emergency notifications are included in DCI and PDCCH carrying this DCI is addressed to P-RNTI.

In the RRC idle/inactive mode UE monitors one paging occasion (PO) every DRX cycle. In the RRC idle/inactive mode UE monitors PO in initial DL BWP. In RRC connected state UE monitors one or more POs to receive SI update notification and to receive emergency notifications. UE can monitor any PO in paging DRX cycle and monitors at least one PO in SI modification period. In the RRC idle/inactive mode UE monitors PO in its active DL BWP. A PO is a set of ‘S’ PDCCH monitoring occasions for paging, where ‘S’ is the number of transmitted Synchronization Signal and PBCH blocks (SSBs) which consist of primary synchronization signal (PSS) and secondary synchronization signal (SSS) and PBCH) in cell. UE first determines the paging frame (PF) and then determines the PO with respect to the determined PF. One PF is a radio frame (10 ms).
The PF for a UE is the radio frame with system frame number ‘SFN’ which satisfies the equation (SFN+PF_offset) mod T=(T div N)*(UE_ID mod N).
Index (i_s), indicating the index of the PO is determined by i_s=floor(UE_ID/N) mod Ns.
T is DRX cycle of the UE.
   In RRC_INACTIVE state, T is determined by the shortest of the UE specific DRX value configured by RRC, UE specific DRX value configured by NAS, and a default DRX value broadcast in system information.
   In RRC_IDLE state, T is determined by the shortest of UE specific DRX value configured by NAS, and a default DRX value broadcast in system information. If UE specific DRX is not configured by upper layers (i.e. NAS), the default value is applied.
N: number of total paging frames in T
Ns: number of paging occasions for a PF
PF_offset: offset used for PF determination
UE_ID: 5G-S-TMSI mod 1024
Parameters Ns, nAndPagingFrameOffset, and the length of default DRX Cycle are signaled in SIB1. The values of N and PF_offset are derived from the parameter nAndPagingFrameOffset. If the UE has no 5G-S-TMSI, for instance when the UE has not yet registered onto the network, the UE shall use as default identity UE_ID=0 in the PF and i_s formulas above.
The PDCCH monitoring occasions for paging are determined based on paging search space configuration (paging-SearchSpace) signaled by gNB.
When SearchSpaceId=0 is configured for pagingSearchSpace, the PDCCH monitoring occasions for paging are same as for RMSI. When SearchSpaceId=0 is configured for pagingSearchSpace, Ns is either 1 or 2. For Ns=1, there is only one PO which starts from the first PDCCH monitoring occasion for paging in the PF. For Ns=2, PO is either in the first half frame (i_s=0) or the second half frame (i_s=1) of the PF.
When SearchSpaceId other than 0 is configured for pagingSearchSpace, the UE monitors the (i_s+1)th PO. The PDCCH monitoring occasions for paging are determined based on paging search space configuration (paging-SearchSpace) signaled by gNB. The PDCCH monitoring occasions for paging which are not overlapping with UL symbols (determined according to tdd-UL-DL-ConfigurationCommon) are sequentially numbered from zero starting from the 1st PDCCH monitoring occasion for paging in the PF. The gNB may signal parameter firstPDCCH-MonitoringOccasionOfPO for each PO corresponding to a PF. When firstPDCCH-MonitoringOccasionOfPO is signalled, the (i_s+1)th PO is a set of ‘S’ consecutive PDCCH monitoring occasions for paging starting from the PDCCH monitoring occasion number indicated by firstPDCCH-MonitoringOccasionOfPO (i.e. the (i_s+1)th value of the firstPDCCH-MonitoringOccasionOfPO parameter). Otherwise, the (i_s+1)th PO is a set of ‘S’ consecutive PDCCH monitoring occasions for paging starting from the (i_s*S)th PDCCH monitoring occasion for paging. ‘S’ is the number of actual transmitted SSBs determined according to parameter ssb-PositionsInBurst signalled in SystemInformationBlock1 received from gNB. The parameter first-PDCCH-MonitoringOccasionOfPO is signalled in SIB1 for paging in initial DL BWP. For paging in a DL BWP other than the initial DL BWP, the parameter first-PDCCH-MonitoringOccasionOfPO is signaled in the corresponding BWP configuration.

The PDCCH addressed to P-RNTI carries information according to DCI format 1_0. The following information is transmitted by means of the DCI format 1_0 with CRC scrambled by P-RNTI:
Short Messages Indicator—2 bits according to Table 1.
Short Messages—8 bits according to Table 2. If only the scheduling information for Paging is carried, this bit field is reserved.
   Frequency domain resource assignment—┌log₂(N_{RB}^{DL,BWP}(N_{RB}^{DL,BWP}+1)/2)┐ bits. If only the short message is carried, this bit field is reserved.
      N_{RB}^{DL,BWP} is the size of CORESET 0
Time domain resource assignment—4 bits. If only the short message is carried, this bit field is reserved.
VRB-to-PRB mapping—1 bit. If only the short message is carried, this bit field is reserved.
Modulation and coding scheme—5 bits. If only the short message is carried, this bit field is reserved.
TB scaling—2 bits. If only the short message is carried, this bit field is reserved.
Reserved bits—6 bits

Table 1 defines the Short Message indicator

TABLE 1

| Bit field | Short Message indicator |
|---|---|
| 00 | Reserved |
| 01 | Only scheduling information for Paging is present in the DCI |
| 10 | Only short message is present in the DCI |
| 11 | Both scheduling information for Paging and short message are |
| | present in the DCI |

Table 2 defines Short Message. Bit 1 is the most significant bit.

TABLE 2

| Bit | Short Message |
|---|---|
| 1 | systemInfoModification |
| | If set to 1: indication of a broadcast control channel (BCCH) |
| | modification other than SIB6, SIB7 and SIB8. |
| 2 | etwsAndCmasIndication |
| | If set to 1: indication of an Earthquake Tsunami Warning System |
| | (ETWS) primary notification and/or an ETWS secondary |
| | notification and/or a Commercial Mobile Alert System (CMAS) |
| | notification. |
| 3-8 | Reserved |

In the fifth generation wireless communication system, support of multimedia broadcast multicast service (MBMS) for RRC IDLE and RRC INACTIVE UEs is being studied. For receiving MBMS packets or MBS (multimedia broadcast service (MBS) packets, UE needs to monitor PDCCH addressed to one or more RNTIs specific to MBMS. DCI transmitted in PDCCH indicates scheduling information of TB carrying MBMS packets.

For Unicast PDCCH Reception in frequency range 2 (FR2) or for beam formed transmission/reception: UE is configured with a search space to monitor. Search space is associated with a Coreset (controlResourceSetId is indicated in search space configuration). Coreset includes a list of TCI states. One of the TCI state is activated via MAC CE. PDCCH transmission is QCLed with DL RS indicated in activated TCI state. This means that PDCCH transmission has same spatial characteristics as the transmission of DL RS indicated in activated TCI state.

For Unicast PDSCH Reception in FR2 or for beam formed transmission/reception: One of the two approaches is used:
Alt 1: PDSCH transmission is QCLed with corresponding PDCCH transmission.
Alt 2: TCI state for PDSCH is indicated by DCI (amongst a set of TCI states activated by MAC control element (CE))

According to the above, for MBS in RRC IDLE/INACTIVE state, GNB needs to transmit MBMS (or, MBS) control channel packets or MBS traffic channel packets using transmission beams covering the entire cell. MBS control channel is also referred as MCCH. MBS traffic channel is also referred as MTCH. MTCH is defined as a point-to-multipoint downlink channel for transmitting MBS data of either multicast session or broadcast session from the network to the UE. MCCH is defined as a point-to-multipoint downlink channel used for transmitting MBS control information from the network to the UE.

Also, search space for monitoring PDCCH for MBS (e.g. PDCCH is addressed to G-RNTI (group RNTI) for transmission of MTCH packets, PDCCH is addressed to MCCH-RNTI for transmission of MCCH packets) can be signaled by GNB. Since the PDCCH addressed to G-RNTI or MCCH-RNTI is transmitted using multiple transmission beams, UE needs to know which PDCCH monitoring occasion is associated with which transmission beam and which PDCCH monitoring occasion(s) it should monitor.

Hereinafter, an embodiment of MBMS Reception in RRC IDLE/RRC INACTIVE state will be described in detail.

### Embodiment 1

UE acquires the master information block (MIB), SIB1 and any other essential SIB needed for MBMS operation.

UE receives search space configuration for monitoring PDCCH for MBMS (PDCCH for MBMS traffic channel can be addressed to G-RNTI(s) or PDCCH for MBMS control channel can be addressed to MCCH-RNTI) traffic channel or control channel from gNB.

The configuration can be received in SIB or dedicated RRC signaling (e.g. RRC Release message or RRC Reconfiguration message).

A list of search space configuration(s) is received from gNB. Each search space configuration is identified by search space ID. Search space ID of search space configuration to be used for monitoring PDCCH for MBMS traffic channel or PDCCH for MBMS control channel is signaled by gNB. Search space type in search space configuration indicates whether DCI format specific to MBMS can be received using that search space configuration or not.

UE identifies the PDCCH monitoring occasions according to parameters, monitoringSlotPeriodicityAndOffset, Duration and monitoringSymbolsWithinSlot in search space configuration for MBMS.

Mapping rule between PDCCH monitoring occasions and transmission beams (or, SSBs) are defined as below.
UE sequentially numbers the valid PDCCH monitoring occasions in SFN cycle.
   The PDCCH monitoring occasions overlapping with UL symbols (according to IE tdd-UL-DL-ConfigurationCommon received in SI) are considered invalid.
Each transmitted SSB (indicated by ssb-PositionsInBurst in SIB1) is also sequentially numbered in increasing order of SSB IDs.
   Parameter ssb-PositionsInBurst indicates which SSBs are transmitted.

PDCCH monitoring occasion number ‘X’ is mapped to K-th transmitted SSB where K=X mod ‘Number of transmitted SSBs’, X=0, 1, 2, . . . .

Or, another mapping rule between PDCCH monitoring occasions and transmission beams (or, SSBs) are defined as below.

PDCCH monitoring occasions in SFN cycle which are not overlapping with UL symbols (determined according to tdd-UL-DL-ConfigurationCommon) are sequentially numbered from one. The [xXN+K]-th PDCCH monitoring occasion (s) for MBMS reception corresponds to the K-th transmitted SSB, where x=0, 1, . . . X−1, K=1, 2, . . . N, N is the number of actual transmitted SSBs determined according to ssb-PositionsInBurst in SIB1 and X is equal to CEIL (number of PDCCH monitoring occasions for MBMS reception/N). The actual transmitted SSBs are sequentially numbered from one in ascending order of their SSB indexes.

UE measures the SS-RSRP of the transmitted SSBs.

For MBMS reception, UE monitors PDCCH (i.e., PDCCH addressed to RNTI specific to MBMS, e.g. G-RNTI (group RNTI) for transmission of MTCH packets or PDCCH addressed to MCCH-RNTI for transmission of MCCH packets) in PDCCH monitoring occasions corresponding to a suitable SSB.

Here, suitable SSB is an SSB with highest SS-RSRP or SSB with SS-RSRP>threshold.

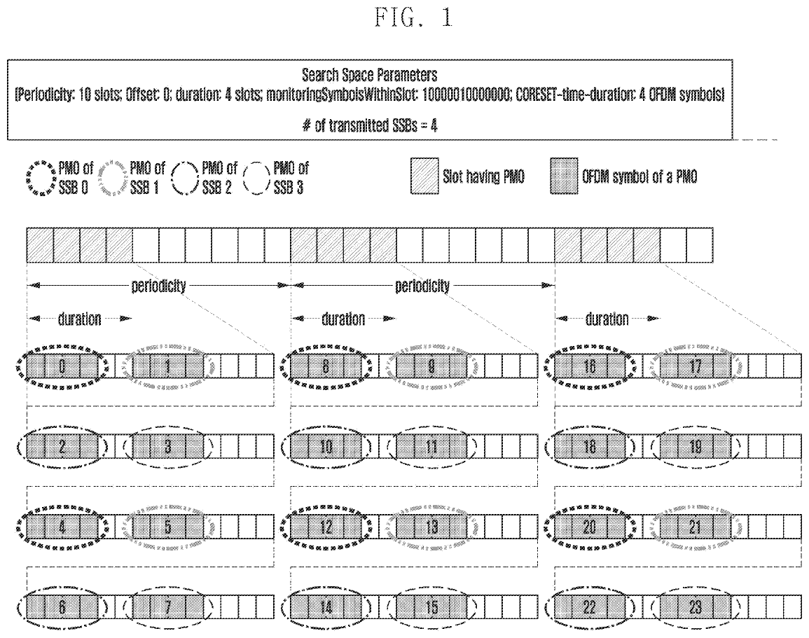

FIG. 1 illustrates an example of MBMS reception in accordance with an embodiment of the disclosure. FIG. 1 is an example illustration of the above operation. In the example number of transmitted SSBs are 4 and these are sequentially numbered as SSB 0, SSB 1, SSB2 and SSB3 in ascending order of SSB IDs. PDCCH monitoring occasions in SFN cycle are sequentially numbered and mapped to SSBs.

### Embodiment 2

UE acquires the MIB, SIB1 and any other essential SIB needed for MBMS operation.

UE receives search space configuration for monitoring PDCCH for MBMS (PDCCH for MBMS can be addressed to G-RNTI (s) or PDCCH for MBMS control channel can be addressed to MCCH-RNTI) traffic channel or control channel) from gNB.

The configuration can be received in SIB or dedicated RRC signaling (e.g. RRC Release message or RRC Reconfiguration message).

A list of search space configuration(s) is received from gNB. Each search space configuration is identified by search space ID. Search space ID of search space configuration to be used for monitoring PDCCH for MBMS traffic channel or PDCCH for MBMS control channel is signaled by gNB. Search space type in search space configuration indicates whether DCI format specific to MBMS can be received using that search space configuration or not.

UE identifies the PDCCH monitoring occasions according to parameters, monitoringSlotPeriodicityAndOffset, Duration and monitoringSymbolsWithinSlot in search space configuration for MBMS.

Mapping rule between PDCCH monitoring occasions and transmission beams (or, SSBs) are defined as below.
UE sequentially numbers the valid PDCCH monitoring occasions in each ‘duration’ of search space.
   The PDCCH monitoring occasions overlapping with UL symbols (according to IE tdd-UL-DL-ConfigurationCommon received in SI) are considered invalid.
Each transmitted SSB (indicated by ssb-PositionsInBurst in SIB1) is also sequentially numbered in increasing order of SSB IDs.
   Parameter ssb-PositionsInBurst indicates which SSBs are transmitted.
PDCCH monitoring occasion number ‘X’ is mapped to Kth transmitted SSB where K=X mod ‘Number of transmitted SSBs’, X=0, 1, 2, . . . .

Or, another mapping rule between PDCCH monitoring occasions and transmission beams (or, SSBs) are defined as below.

PDCCH monitoring occasions in each ‘duration’ of search space which are not overlapping with UL symbols (determined according to tdd-UL-DL-ConfigurationCommon) are sequentially numbered from one. The [xXN+K]-th PDCCH monitoring occasion (s) for MBMS reception corresponds to the K-th transmitted SSB, where x=0, 1, . . . X−1, K=1, 2, . . . N, N is the number of actual transmitted SSBs determined according to ssb-PositionsInBurst in SIB1 and X is equal to CEIL (number of PDCCH monitoring occasions for MBMS reception/N). The actual transmitted SSBs are sequentially numbered from one in ascending order of their SSB indexes.

UE measures the SS-RSRP of the transmitted SSBs.

For MBMS reception, UE monitors PDCCH (PDCCH addressed to RNTI specific to MBMS, e.g. G-RNTI (group RNTI) for transmission of MTCH packets or PDCCH addressed to MCCH-RNTI for transmission of MCCH packets) in PDCCH monitoring occasions corresponding to a suitable SSB.

Here, suitable SSB is an SSB with highest SS-RSRP or SSB with SS-RSRP>threshold.

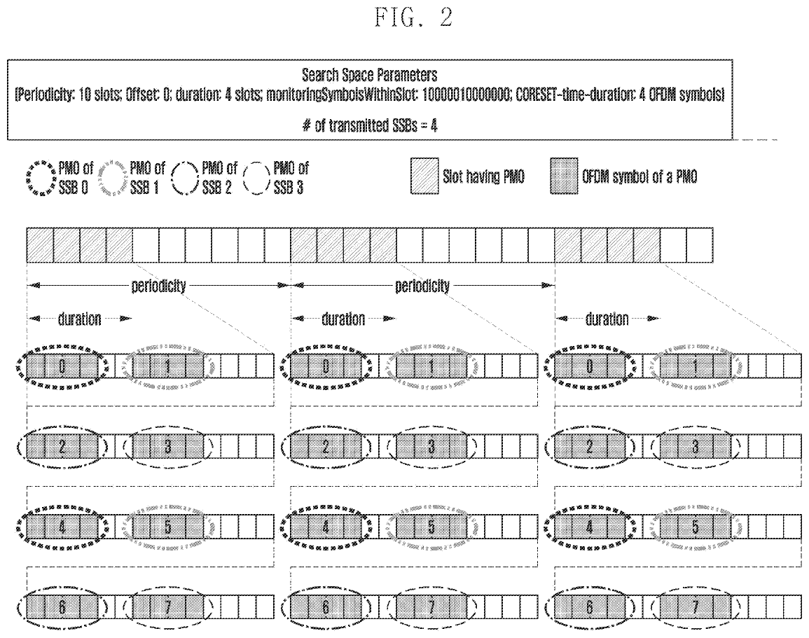

FIG. 2 illustrates another example of MBMS reception in accordance with another embodiment of the disclosure. FIG. 2 is an example illustration of the above operation. In the example number of transmitted SSBs are 4 and these are sequentially numbered as SSB 0, SSB 1, SSB2 and SSB3 in ascending order of SSB IDs. PDCCH monitoring occasions in each ‘duration’ of search space are sequentially numbered and mapped to SSBs.

### Embodiment 3

UE acquires the MIB, SIB1 and any other essential SIB needed for MBMS operation.

UE receives search space configuration for monitoring PDCCH for MBMS (PDCCH for MBMS can be addressed to G-RNTI (s) or PDCCH for MBMS control channel can be addressed to MCCH-RNTI) traffic channel or control channel from gNB.

The configuration can be received in SIB or dedicated RRC signaling (e.g. RRC Release message or RRC Reconfiguration message).

A list of search space configuration(s) is received from gNB. Each search space configuration is identified by search space ID. Search space ID of search space configuration to be used for monitoring PDCCH for MBMS traffic channel or PDCCH for MBMS control channel is signaled by gNB. Search space type in search space configuration indicates whether DCI format specific to MBMS can be received using that search space configuration or not.

UE receives configuration of PDCCH monitoring window for MBMS.

Period, offset, duration of Window, Period and offset are with respect to SFN 0. Offset can be zero. In an example, Window start at SFN mod period=offset. In an embodiment, duration of window may not be signaled and window is entire duration of a period i.e. duration of window is same as period, i.e. MBMS window is the MBMS period.

UE identifies the PDCCH monitoring occasions according to parameters, monitoringSlotPeriodicityAndOffset, Duration and monitoringSymbolsWithinSlot in search space configuration for MBMS.

Here, mapping rule between PDCCH monitoring occasions and transmission beams (or, SSBs) are defined as below.
UE sequentially numbers the valid PDCCH monitoring occasions in MBMS window
   The PDCCH monitoring occasions overlapping with UL symbols (according to IE tdd-UL-DL-ConfigurationCommon received in SI) are considered invalid
Each transmitted SSB (indicated by ssb-PositionsInBurst in SIB1) is also sequentially numbered in increasing order of SSB IDs
   Parameter ssb-PositionsInBurst indicates which SSBs are transmitted
PDCCH monitoring occasion number ‘X’ in MBMS window is mapped to K-th transmitted SSB where K=X mod ‘Number of transmitted SSBs’, X=0, 1, 2, . . . .

Or, another mapping rule between PDCCH monitoring occasions and transmission beams (or, SSBs) are defined as below.

PDCCH monitoring occasions in MBMS window which are not overlapping with UL symbols (determined according to tdd-UL-DL-ConfigurationCommon) are sequentially numbered from one. The [xXN+K]-th PDCCH monitoring occasion (s) for MBMS reception corresponds to the K-th transmitted SSB, where x=0, 1, . . . X−1, K=1, 2, . . . N, N is the number of actual transmitted SSBs determined according to ssb-PositionsInBurst in SIB1 and X is equal to CELL (number of PDCCH monitoring occasions for MBMS reception in window/N). The actual transmitted SSBs are sequentially numbered from one in ascending order of their SSB indexes.

UE measures the SS-RSRP of the transmitted SSBs.

For MBMS reception, UE monitors PDCCH (PDCCH addressed to RNTI specific to MBMS, e.g. G-RNTI for MBMS traffic channel or PDCCH for MBMS control channel can be addressed to MCCH-RNTI) traffic channel or control channel in PDCCH monitoring occasions corresponding to a suitable SSB

Suitable SSB: SSB with highest SS-RSRP or SSB with SS-RSRP>threshold

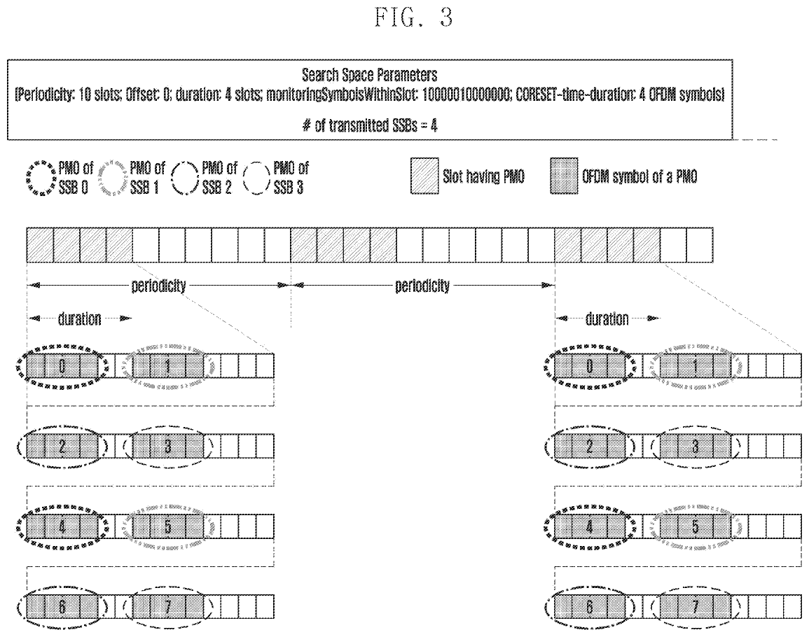

FIG. 3 illustrates another example of MBMS reception in accordance with another embodiment of the disclosure. FIG. 3 is an example illustration of the above operation. In the example number of transmitted SSBs are 4 and these are sequentially numbered as SSB 0, SSB 1, SSB2 and SSB3 in ascending order of SSB IDs. PDCCH monitoring occasions in each ‘duration’ of search space are sequentially numbered and mapped to SSBs. MBS window may span partial ‘duration’ or one or more ‘duration’ period of search space.

### Embodiment 4

UE acquires the MIB, SIB1 and any other essential SIB needed for MBMS operation.

PDCCH monitoring occasions for MBMS reception are same as the occasions in which SSBs are transmitted in time domain.

In frequency domain the SSBs and PDCCH for MBMS are frequency division multiplexed (FDMed). Starting PRB and number of PRBs for receiving PDCCH can be signaled. Alternately offset between last PRB of SSB and starting PRB for PDCCH and number of PRBs can be signaled.

The PRBs for receiving PDCCH for MBMS is indicated in SI.

The PDCCH transmission for MBMS traffic channel or PDCCH for MBMS control channel in PDCCH monitoring occasion (PMO) is QCLed with SSB transmission FDMed with this PDCCH transmission.

UE measures the SS-RSRP of the transmitted SSBs.

For MBMS reception, UE monitors PDCCH (PDCCH addressed to RNTI specific to MBMS, e.g. PDCCH for MBMS traffic channel can be addressed to G-RNTI or PDCCH for MBMS control channel can be addressed to MCCH-RNTI) traffic channel or control channel in PDCCH monitoring occasions corresponding to a suitable SSB.

Suitable SSB: SSB with highest SS-RSRP or SSB with SS-RSRP>threshold.

This embodiment may be applied if search space ID for MBMS is configured (e.g. in SI or RRC signaling) by gNB as zero.

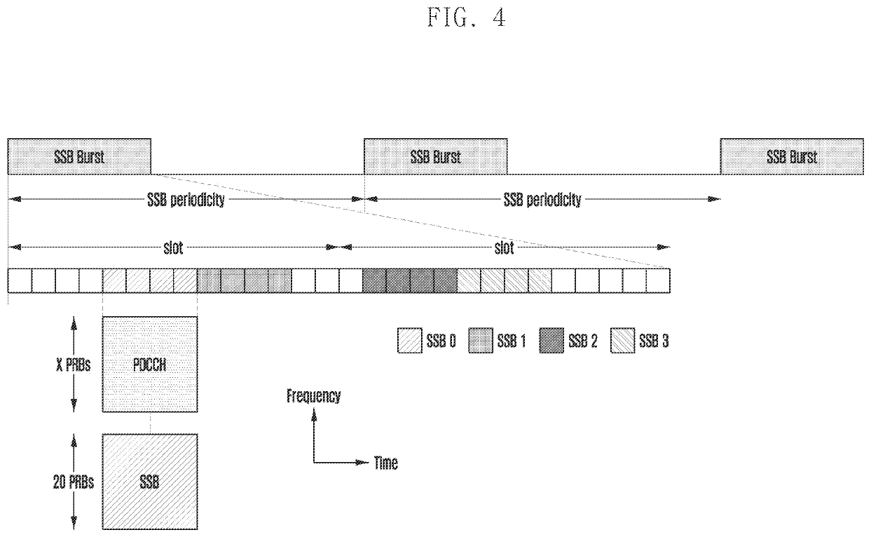

FIG. 4 illustrates another example of MBMS reception in accordance with another embodiment of the disclosure. FIG. 4 is an example illustration of the above operation. SSB burst comprise of four SSB occasions. Each SSB occasion occupies 4 OFDM symbols. PDCCH monitoring occasion for MBMS reception corresponding to SSB 0 is FDMed with SSB 0 in OFDM symbols of SSB 0. Similarly, for SSB1 to SSB 3.

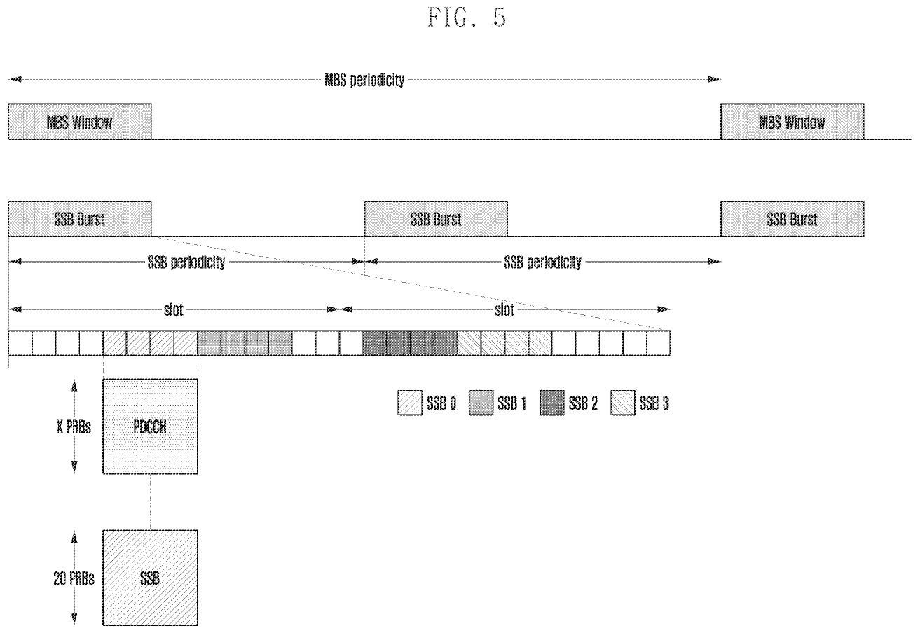

FIG. 5 illustrates another example of MBMS reception in accordance with another embodiment of the disclosure. In FIG. 5, MBMS window can also be defined in this embodiment similar to embodiment 3. PDCCH monitoring occasions for MBMS reception are FDMed with SSB occasions within the MBS window. MBS window may span one or multiple SSB bursts.

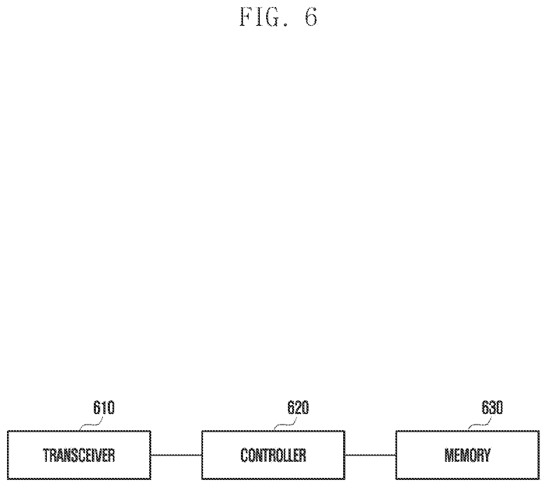

FIG. 6 is a block diagram of a terminal according to an embodiment of the disclosure.

Referring to FIG. 6, a terminal includes a transceiver 610, a controller 620 and a memory 630. The controller 620 may refer to a circuitry, an application-specific integrated circuit (ASIC), or at least one processor. The transceiver 610, the controller 620 and the memory 630 are configured to perform the operations of the terminal (e.g., UE) illustrated in the figures, e.g. FIGS. 1 to 5, or described above. Although the transceiver 610, the controller 620 and the memory 630 are shown as separate entities, they may be realized as a single entity like a single chip. Or, the transceiver 610, the controller 620 and the memory 630 may be electrically connected to or coupled with each other.

The transceiver 610 may transmit and receive signals to and from other network entities, e.g., a base station.

The controller 620 may control the UE to perform functions according to one of the embodiments described above. For example, the controller 620 controls the UE to perform MBS reception or MBMS reception from the base station.

In an embodiment, the operations of the terminal may be implemented using the memory 630 storing corresponding program codes. Specifically, the terminal may be equipped with the memory 630 to store program codes implementing desired operations. To perform the desired operations, the controller 620 may read and execute the program codes stored in the memory 630 by using a processor or a central processing unit (CPU).

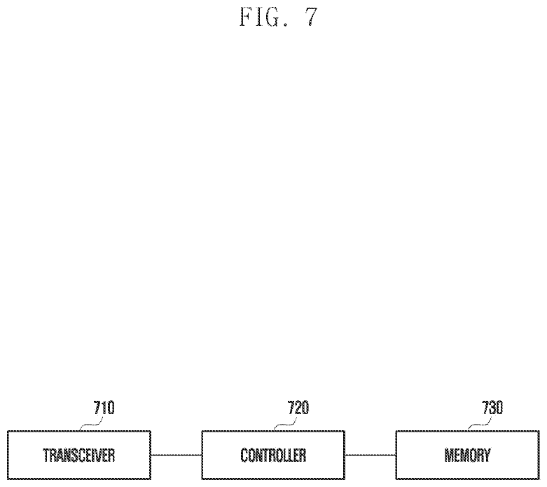

FIG. 7 is a block diagram of a base station according to an embodiment of the disclosure.

Referring to FIG. 7, a base station includes a transceiver 710, a controller 720 and a memory 730. The transceiver 710, the controller 720 and the memory 730 are configured to perform the operations of the network (e.g., gNB) illustrated in the figures, e.g. FIGS. 1 to 5, or described above. Although the transceiver 710, the controller 720 and the memory 730 are shown as separate entities, they may be realized as a single entity like a single chip. The transceiver 710, the controller 720 and the memory 730 may be electrically connected to or coupled with each other.

The transceiver 710 may transmit and receive signals to and from other network entities, e.g., a terminal.

The controller 720 may control the base station to perform functions according to one of the embodiments described above. For example, the controller 720 controls the base station to perform MBS transmission or MBMS transmission to the UE.

The controller 720 may refer to a circuitry, an ASIC, or at least one processor. In an embodiment, the operations of the base station may be implemented using the memory 730 storing corresponding program codes. Specifically, the base station may be equipped with the memory 730 to store program codes implementing desired operations. To perform the desired operations, the controller 720 may read and execute the program codes stored in the memory 730 by using a processor or a CPU.

While the disclosure has been shown and described with reference to various embodiments thereof, it will be understood by those skilled in the art that various changes in form and details may be made therein without departing from the spirit and scope of the disclosure as defined by the appended claims and their equivalents.

As described above, embodiments disclosed in the specification and drawings are merely used to present specific examples to easily explain the contents of the disclosure and to help understanding, but are not intended to limit the scope of the disclosure. Accordingly, the scope of the disclosure should be analyzed to include all changes or modifications derived based on the technical concept of the disclosure in addition to the embodiments disclosed herein.

1. A method performed by a terminal in a wireless communication system, the method comprising:
receiving, from a base station, search space configuration information associated with physical downlink control channel (PDCCH) monitoring occasion for a multimedia broadcast service (MBS) and window configuration information for the MBS;
identifying at least one PDCCH monitoring occasion within a window based on the search space configuration information and the window configuration information, wherein the at least one PDCCH monitoring occasion is not overlapped with uplink symbols determined based on a time division duplexing (TDD) configuration;
receiving, from the base station, control information based on monitoring the at least one PDCCH monitoring occasion within the window; and
receiving, from the base station, an MBS data based on the control information.

2. The method of claim 1, wherein the at least one PDCCH monitoring occasion is sequentially numbered from one in the window,
wherein at least one actual transmitted synchronization signal block (SSB) is sequentially numbered from one in ascending order of an index of the at least one actual transmitted SSB, and
wherein a (x*N+k)-th PDCCH monitoring occasion corresponds to a k-th SSB,
where x=0, 1, . . . , X−1, X is equal to ceil{(number of PDCCH monitoring occasions for the MBS in the window)/N}, N is number of the at least one actual transmitted SSB, and K=1, 2, . . . , N.

3. The method of claim 1, wherein a list of search space configurations is received from the base station, and
wherein the search space configuration information includes an indication indicating one of the search space configurations.

4. The method of claim 1, wherein the search space configuration information and the window configuration information are included in system information or an RRC message.

5. A method performed by a base station in a wireless communication system, the method comprising:
transmitting, to a terminal, search space configuration information associated with physical downlink control channel (PDCCH) monitoring occasion for a multimedia broadcast service (MBS) and window configuration information for the MBS;
identifying at least one PDCCH monitoring occasion within a window based on the search space configuration information and the window configuration information, wherein the at least one PDCCH monitoring occasion is not overlapped with uplink symbols determined based on a time division duplexing (TDD) configuration;
transmitting, to the terminal, control information based on the at least one PDCCH monitoring occasion within the window; and
transmitting, to the terminal, an MBS data based on the control information.

6. The method of claim 5, wherein the at least one PDCCH monitoring occasion is sequentially numbered from one in the window,
wherein at least one actual transmitted synchronization signal block (SSB) is sequentially numbered from one in ascending order of an index of the at least one actual transmitted SSB, and
wherein a (x*N+k)-th PDCCH monitoring occasion corresponds to a k-th SSB,
where x=0, 1, . . . , X−1, X is equal to ceil{(number of PDCCH monitoring occasions for the MBS in the window)/N}, N is number of the at least one actual transmitted SSB, and K=1, 2, . . . , N.

7. The method of claim 5, wherein a list of search space configurations is transmitted to the terminal,
wherein the search space configuration information includes an indication indicating one of the search space configurations, and
wherein the search space configuration information and the window configuration information are included in system information or an RRC message.

8. A terminal in a wireless communication system, the terminal comprising:
a transceiver; and
a controller coupled with the transceiver and configured to:
receive, from a base station, search space configuration information associated with physical downlink control channel (PDCCH) monitoring occasion for a multimedia broadcast service (MBS) and window configuration information for the MBS,
identify at least one PDCCH monitoring occasion within a window based on the search space configuration information and the window configuration information, wherein the at least one PDCCH monitoring occasion is not overlapped with uplink symbols determined based on a time division duplexing (TDD) configuration,
receive, from the base station, control information based on monitoring the at least one PDCCH monitoring occasion within the window, and
receive, from the base station, an MBS data based on the control information.

9. The terminal of claim 8, wherein the at least one PDCCH monitoring occasion is sequentially numbered from one in the window,
wherein at least one actual transmitted synchronization signal block (SSB) is sequentially numbered from one in ascending order of an index of the at least one actual transmitted SSB, and
wherein a (x*N+k)-th PDCCH monitoring occasion corresponds to a k-th SSB,
where x=0, 1, . . . , X−1, X is equal to ceil{(number of PDCCH monitoring occasions for the MBS in the window)/N}, N is number of the at least one actual transmitted SSB, and K=1, 2, . . . , N.

10. The terminal of claim 8, wherein a list of search space configurations is received from the base station, and,
wherein the search space configuration information includes an indication indicating one of the search space configurations.

11. The terminal of claim 8, wherein the search space configuration information and the window configuration information are included in system information or an RRC message.

12. A base station in a wireless communication system, the base station comprising:
a transceiver; and
a controller coupled with the transceiver and configured to:
transmit, to a terminal, search space configuration information associated with physical downlink control channel (PDCCH) monitoring occasion for a multimedia broadcast service (MBS) and window configuration information for the MBS,
identify at least one PDCCH monitoring occasion within a window based on the search space configuration information and the window configuration information, wherein the at least one PDCCH monitoring occasion is not overlapped with uplink symbols determined based on a time division duplexing (TDD) configuration,
transmit, to the terminal, control information based on the at least one PDCCH monitoring occasion within the window, and
transmit, to the terminal an MBS data based on the control information.

13. The base station of claim 12, wherein the at least one PDCCH monitoring occasion is sequentially numbered from one in the window,
wherein at least one actual transmitted synchronization signal block (SSB) is sequentially numbered from one in ascending order of an index of the at least one actual transmitted SSB, and
wherein a (x*N+k)-th PDCCH monitoring occasion corresponds to a k-th SSB,
where x=0, 1, . . . , X−1, X is equal to ceil{(number of PDCCH monitoring occasions for the MBS in the window)/N}, N is number of the at least one actual transmitted SSB, and K=1, 2, . . . , N.

14. The base station of claim 12, wherein a list of search space configurations is transmitted to the terminal, and
wherein the search space configuration information includes an indication indicating one of the search space configurations.

15. The base station of claim 12, wherein the search space configuration information and the window configuration information are included in system information or an RRC message.
